(19) United States
(12) Patent Application Publication
(10) Pub. No.: US 2014/0364298 A1
(43) Pub. Date: Dec. 11, 2014

(54) METHOD FOR PRODUCING CHEMICALLY TEMPERED GLASS, AND GLASS FOR CHEMICAL TEMPERING

(71) Applicant: Asahi Glass Company, Limited, Chiyoda-ku (JP)

(72) Inventors: Seiki OHARA, Chiyoda-ku (JP); Kazutaka ONO, Chiyoda-ku (JP); Tetsuya NAKASHIMA, Chiyoda-ku (JP)

(73) Assignee: Asahi Glass Company, Limited, Chiyoda-ku (JP)

(21) Appl. No.: 14/470,395

(22) Filed: Aug. 27, 2014

Related U.S. Application Data
(63) Continuation of application No. 13/419,115, filed on Mar. 13, 2012.

(30) Foreign Application Priority Data
Apr. 18, 2011 (JP) 2011-092140
Apr. 18, 2011 (JP) 2011-092141
Dec. 15, 2011 (JP) 2011-274695

(51) Int. Cl. C03C 3/087; C03C 4/18; C03C 3/085

(52) U.S. Cl. CPC C03C 3/087; C03C 3/085; C03C 4/18; C03C 2204/00
USPC 501/70; 501/69

(57) ABSTRACT

A Glass for chemical tempering, which includes, as represented by mole percentage based on the following oxides, from 60 to 75% of SiO₂, from 5 to 15% of Al₂O₃, more than 7 and at most 12% of MgO, from 0 to 3% of CaO, from 0 to 3% of ZrO₂, from 10 to 20% of Li₂O, from 0 to 8% of Na₂O and from 0 to 5% of K₂O, and has a total content R₂O of Li₂O, Na₂O and K₂O of at most 25%, and a ratio Li₂O/R₂O of the Li₂O content to R₂O of from 0.5 to 1.0.

### CROSS REFERENCE TO RELATED APPLICATION

This application is a continuation of U.S. application Ser. No. 13/419,115, filed on Mar. 13, 2012, and claims priority to Japanese Patent Application Nos: i). 2011-092140, filed on Apr. 18, 2011; ii) 2011-092141, filed on Apr. 18, 2011; and iii) 2011-274695, filed on Dec. 15, 2011.

### TECHNICAL FIELD

The present invention relates to a mobile device such as a cell phone or a personal digital assistance (PDA), a touch panel, a display device for e.g. a large-sized flat screen television such as a large-sized liquid crystal television, a glass plate for a display device suitable as e.g. a cover glass for a display device, chemically tempered glass for e.g. a chemically tempered glass plate suitable for such a glass plate, a method for producing such chemically tempered glass, and glass for chemical tempering.

### BACKGROUND ART

In recent years, for mobile devices such as cell phones, PDA, etc., touch panels, and display devices such as liquid crystal televisions, use of a cover glass (protective glass) for protecting a display and improving appearance, is increasing.

Further, weight reduction and thickness reduction are required for such portable digital devices. Therefore, a cover glass used for protecting a display is also required to be thin. However, if the thickness of the cover glass is made to be thin, the strength is lowered, and if a portable device is hit by something during its use or the portable device is dropped at the time of carrying it, the cover glass itself may sometimes be broken. Therefore, there is a problem that the cover glass cannot accomplish the essential role to protect display devices.

Further, in the case of a large-sized flat screen television, the cover glass itself is large, and accordingly the probability of the breakage is high, and in addition, it has been required to make the cover glass thin for weight reduction, and in this view also, the probability of the breakage of the cover glass is high.

In order to solve the above problem, it is conceivable to improve the strength of the cover glass, and as such a method, a method to form a compressive stress layer on a glass surface is commonly known.

As the method to form a compressive stress layer on a glass surface, typical are an air quenching tempering method (physical tempering method) wherein a surface of a glass plate heated to near the softening point is quenched by air cooling or the like and a chemical tempering method wherein alkali metal ions having a small ion radius (typically Li ions or Na ions) on a glass plate surface are exchanged with alkali ions having a larger ion radius (typically K ions) by ion exchange at a temperature lower than the glass transition point (Tg).

As mentioned above, the thickness of the cover glass is required to be thin. If the air quenching tempering method is applied to a thin glass plate, the temperature difference between the surface and the inside tends not to arise, and it is thereby difficult to form a compressive stress layer, and the desired property of high strength cannot be obtained. Therefore, a cover glass tempered by the latter chemical tempering method has been proposed (Patent Documents 1 to 3).

Patent Document 1: JP-A-2005-320234

Patent Document 2: U.S. Patent Application Publication No. 2009/298669

Patent Document 3: WO2008/143999

### DISCLOSURE OF INVENTION

### Technical Problem

In Examples disclosed in Patent Documents 1 to 3, chemical tempering treatment at a high temperature exceeding 450° C. or chemical tempering treatment for a long period of time exceeding 4 hours is required in all cases.

For chemical tempering, nitrate salts of sodium and potassium are typically used, and at a temperature exceeding 450° C., the vapor pressures of them tend to be high, and they are very likely to volatilize. If such volatilization occurs, the quality of glass subjected to chemical tempering tends to be unstable and in addition, ancillary facilities to recover the volatilized products will be required, such being problematic in view of the quality and the cost. Further, chemical tempering treatment for a long period of time leads directly to the cost increase and is thereby unfavorable.

It is an object of the present invention to provide glass for chemical tempering, which will acquire sufficient strength even by chemical tempering at a low temperature for a short time, and a method for producing chemically tempered glass, by using such glass for chemical tempering.

### Solution to Problem

The present invention provides the following.

(1) Glass for chemical tempering, which comprises, as represented by mole percentage based on the following oxides, from 60 to 75% of SiO₂, from 5 to 15% of Al₂O₃, from 1 to 12% of MgO, from 0 to 3% of CaO, from 0 to 3% of ZrO₂, from 10 to 20% of Li₂O, from 0 to 8% of Na₂O and from 0 to 5% of K₂O, and has a total content R₂O of Li₂O, Na₂O and K₂O of at most 25%, and a ratio Li₂O/R₂O of the Li₂O content to R₂O of from 0.5 to 1.0 (hereinafter referred to as the glass of the present invention). Further, in this specification, e.g. “contains from 0 to 8% of Na₂O” means that Na₂O is not essential but may be contained in a range of up to 8%.

(2) The glass for chemical tempering according to (1), wherein MgO is at most 7%.

(3) Glass for chemical tempering, which comprises, as represented by mole percentage based on the following oxides, from 66 to 75% of SiO₂, at least 5 and less than 9% of Al₂O₃, from 1 to 7% of MgO, from 0 to 3% of CaO, from 0 to 3% of ZrO₂, from 10 to 20% of Li₂O, from 0 to 6% of Na₂O and from 0 to 5% of K₂O, and has R₂O of at most 25%, and Li₂O/R₂O of from 0.6 to 1.0 (hereinafter referred to as the glass A of the present invention).

(4) The glass for chemical tempering according to (3), wherein the Al₂O₃ content is less than 8%.

(5) The glass for chemical tempering according to (3) or (4), wherein R₂O is at most 20%.

(6) The glass for chemical tempering according to (3), (4) or (5), wherein the total content Na₂O+K₂O of Na₂O and K₂O is from 0 to 6%.

(7) The glass for chemical tempering according to any one of (3) to (6), wherein the difference Li₂O-(Na₂O+K₂O) having Na₂O+K₂O subtracted from the Li₂O content is from 8 to 17%.

(8) Glass for chemical tempering, which comprises, as represented by mole percentage based on the following oxides, from 60 to 73% of SiO₂, from 8 to 15% of Al₂O₃, from 1 to 7% of MgO, from 0 to 3% of CaO, from 0 to 3% of ZrO₂, from 10 to 20% of Li₂O, from 1 to 8% of Na₂O and from 0 to 5% of K₂O, and has R₂O of at most 25%, Na₂O+K₂O of from 2.5 to 10%, and Li₂O/R₂O of from 0.5 to 1.0 (hereinafter referred to as the glass B of the present invention).

(9) The glass for chemical tempering according to (8), wherein Al₂O₃ is at least 9%.

(10) The glass for chemical tempering according to (8), wherein SiO₂ is at least 62%, Al₂O₃ is from 9 to 14%, R₂O is at most 22%, Na₂O+K₂O is from 3 to 8%, and Li₂O/R₂O is at least 0.6.

(11) The glass for chemical tempering according to (8), (9) or (10), wherein Li₂O-(Na₂O+K₂O) is from 4 to 17.5%.

(12) The glass for chemical tempering according to (1), wherein MgO is more than 7%.

(13) The glass for chemical tempering according to (12), wherein SiO₂ is at most 68%, Al₂O₃ is at most 13%, Li₂O is at most 17%, Na₂O is from 0 to 5%, K₂O is from 0 to 3%, R₂O is at most 18%, and Li₂O/R₂O is at least 0.7.

(14) The glass for chemical tempering according to (12) or (13), wherein Al₂O₃ is less than 9%.

(15) The glass for chemical tempering according to (12), (13) or (14), wherein Li₂O is at least 12%.

(16) The glass for chemical tempering according to any one of (1) to (15), wherein X calculated by the following formula by using the contents of the respective components of Al₂O₃, MgO, ZrO₂, Li₂O, Na₂O and K₂O, is at least 40 mol %:

X=2×(Al₂O₃+ZrO₂+Li₂O)+MgO−Na₂O−K₂O

(17) The glass for chemical tempering according to any one of (1) to (16), which contains substantially no B₂O₃.

(18) A glass plate for chemical tempering, which is made of the glass for chemical tempering as defined in any one of (1) to (17).

(19) The glass plate for chemical tempering according to (18), which is produced by a float process or a fusion process.

(20) A chemically tempered glass plate obtained by subjecting the glass plate for chemical tempering as defined in (18) or (19) to chemical tempering treatment (hereinafter referred to as the glass plate of the present invention).

(21) A method for producing chemically tempered glass, which comprises carrying out chemical tempering treatment by immersing the glass for chemical tempering as defined in any one of (1) to (18) in a molten salt, wherein the molten salt contains at least either one of NaNO₃ and KNO₃, and the chemical tempering treatment is carried out at a temperature of the molten salt being at most 425° C. for an immersion time of at most 2 hours.

(22) A glass plate for a display device obtained by subjecting the glass plate for chemical tempering as defined in (18) or (19) to chemical tempering treatment.

(23) A display device provided with the chemically tempered glass plate as defined in (20).

(24) A touch panel provided with the chemically tempered glass plate as defined in (20).

(25) A portable device provided with the chemically tempered glass plate as defined in (20).

(26) A display device having a cover glass, wherein the cover glass is the chemically tempered glass plate as defined in (20).

(27) A television provided with the display device as defined in (26).

(28) A portable device provided with the display device as defined in (26).

(29) A touch panel provided with the display device as defined in (26).

(30) A method for producing chemically tempered glass, which comprises chemically tempering glass for chemical tempering, comprising, as represented by mole percentage based on the following oxides, from 60 to 75% of SiO₂, from 5 to 15% of Al₂O₃, from 1 to 12% of MgO, from 0 to 3% of CaO, from 0 to 3% of ZrO₂, from 10 to 20% of Li₂O, from 0 to 8% of Na₂O and from 0 to 5% of K₂O, and having R₂O of at most 25%, and Li₂O/R₂O of from 0.5 to 1.0.

(31) The method for producing chemically tempered glass according to (30), wherein the glass for chemical tempering contains at most 73% of SiO₂, at least 8% of Al₂O₃, at most 7% of MgO and at least 1% of Na₂O, and has Na₂O+K₂O of from 2.5 to 10%.

(32) The method for producing chemically tempered glass according to (30) or (31), wherein the glass for chemical tempering contains at least 9% of Al₂O₃.

(33) The method for producing chemically tempered glass according to (31) or (32), wherein the glass for chemical tempering contains at least 62% of SiO₂ and from 9 to 14% of Al₂O₃, and has R₂O of at most 22%, Na₂O+K₂O of from 3 to 8%, and Li₂O/R₂O of at least 0.6.

(34) The method for producing chemically tempered glass according to (31), (32) or (33), wherein the glass for chemical tempering is one wherein Li₂O—(Na₂O+K₂O) is from 4 to 17.5%.

(35) The method for producing chemically tempered glass according to (30), wherein the glass for chemical tempering contains at least 62% of SiO₂, less than 9% of Al₂O₃ and at most 6% of Na₂O, and has Li₂O/R₂O of at least 0.6.

(36) The method for producing chemically tempered glass according to (35), wherein the glass for chemical tempering contains at least 66% of SiO₂, less than 8% of Al₂O₃ and at most 7% of MgO.

(37) The method for producing chemically tempered glass according to (35) or (36), wherein the glass for chemical tempering has R₂O of at most 20% and Na₂O+K₂O of from 0 to 6%.

(38) The method for producing chemically tempered glass according to any one of (30) to (37), wherein the glass for chemical tempering is one wherein Li₂O—(Na₂O+K₂O) is from 8 to 17%.

(39) The method for producing chemically tempered glass according to any one of (30) to (38), wherein the glass for chemical tempering is one wherein X calculated by the following formula by using the contents of the respective components of Al₂O₃, MgO, ZrO₂, Li₂O, Na₂O and K₂O, is at least 40 mol %:

X=2×(Al₂O₃+ZrO₂+Li₂O)+MgO−Na₂O−K₂O

(40) The method for producing chemically tempered glass according to any one of (30) to (39), wherein the glass for chemical tempering has Li₂O/R₂O of more than 0.8.

(41) The method for producing chemically tempered glass according to any one of (30) to (40), wherein the glass for chemical tempering contains substantially no B₂O₃.

(42) The method for producing chemically tempered glass according to any one of (30) to (41), wherein the chemical tempering of the glass for chemical tempering is carried out by immersing the glass in a molten salt containing at least either one of NaNO₃ and KNO₃ at a temperature of at most 425° C. for at most 2 hours.

(43) The method for producing chemically tempered glass according to any one of (30) to (42), wherein the glass for chemical tempering is a glass plate.

(44) The method for producing chemically tempered glass according to (43), wherein the glass plate is produced by a float process or a fusion process.

(45) A method for producing a display device provided with a chemically tempered glass plate, which comprises producing the chemically tempered glass plate by the method for producing chemically tempered glass as defined in (43) or (44).

(46) A method for producing a touch panel provided with a chemically tempered glass plate, which comprises producing the chemically tempered glass plate by the method for producing chemically tempered glass as defined in (43) or (44).

(47) A method for producing a portable device provided with a chemically tempered glass plate, which comprises producing the chemically tempered glass plate by the method for producing chemically tempered glass as defined in (43) or (44).

(48) A method for producing a chemically tempered glass plate, which comprises carrying out chemical tempering treatment by immersing the glass plate for chemical tempering as defined in (18) or (19) in a molten salt, wherein the molten salt contains at least either one of NaNO₃ and KNO₃, and the chemical tempering treatment is carried out at a temperature of the molten salt being at most 425° C. for an immersion time of at most 2 hours.

The present inventors have found that it is effective to optimize the Al₂O₃ content and the Li₂O/R₂O ratio so as to obtain sufficient strength even by chemical tempering at a low temperature for a short period of time, and accomplished the present invention. Further, they have found that it is effective that the molten salt contains NaNO₃ so as to obtain sufficient strength even by chemical tempering at a low temperature for a short period of time, and accomplished the present invention.

According to the present invention, it is possible to obtain sufficient strength of a glass plate for a display device even by chemical tempering at a low temperature for a short period of time.

In the glass of Patent Document 1, a large amount of Al₂O₃ is contained in order to promote the ion exchange property, but if the content of Al₂O₃ becomes large, devitrification resistance tends to be poor, and deterioration of the productivity or a load to the installation tends to increase. Whereas, according to a preferred embodiment of the present invention, the content of Al₂O₃ is made low, whereby it is possible to increase the productivity.

### BRIEF DESCRIPTION OF THE DRAWING

FIG. 1 is a graph wherein the abscissa represents X=2×(Al₂O₃+ZrO₂+Li₂O)+MgO−Na₂O−K₂O (unit: mol %), and the ordinate represents the surface compressive stress S (unit: MPa), and plotting was made with respect to Examples 1 to 45 given hereinafter. It is evident that there is a positive correlation between X and S. Here, the dotted line in FIG. 1, is a linear line obtained by fitting by a least-square method.

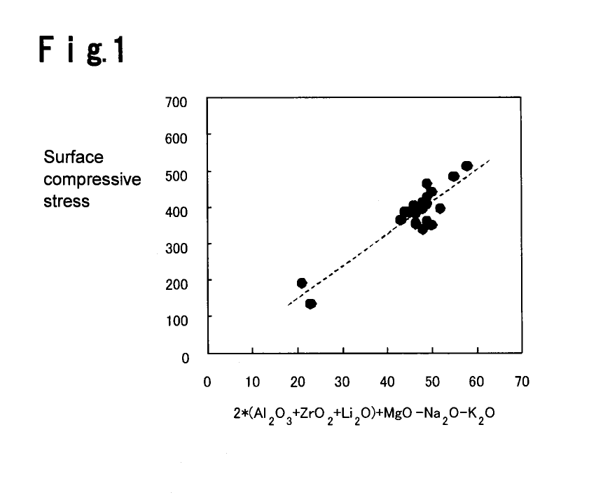

### DESCRIPTION OF EMBODIMENTS

The thickness of the glass plate for chemical tempering of the present invention is typically from 0.3 to 1.5 mm. If the thickness is less than 0.3 mm, a problem may arise from the viewpoint of the strength for practical use. It is more preferably at least 0.5 mm, particularly preferably more than 0.7 mm.

The thickness t of the surface compressive stress layer of the glass plate of the present invention is preferably more than 25 μm. If it is at most 25 μm, the glass may be fragile. It is more preferably at least 30 μm, particularly preferably at least 40 μm, typically at least 45 μm or at least 50 μm. However, it is preferably less than 50 μm, in a case where it is desired to avoid fine pulverization of glass when broken.

The surface compressive stress S of the glass plate of the present invention is typically at least 200 MPa and less than 1,200 MPa. If it is less than 200 MPa, the glass may be fragile. It is more preferably at least 250 MPa, further preferably at least 300 MPa. In a case where the glass plate of the present invention is used for a mobile device, S is preferably at least 400 MPa, more preferably at least 430 MPa.

The specific gravity of the glass of the present invention is preferably at most 2.6. If it exceeds 2.6, in a case where the glass is used for e.g. a mobile device, the mobile device tends to be heavy and poor in portability. It is preferably at most 2.5.

The average linear expansion coefficient at from 50 to 350° C. is preferably from 50×10⁻⁷/° C. to 100×10⁻⁷/° C. If it exceeds 100×10⁻⁷/° C., a strain due to a temperature change is likely to occur, e.g. when left in an automobile. It is more preferably at most 95×10⁻⁷/° C., typically at most 90×10⁻⁷/° C. Further, it is typically at least 60×10⁻⁷/° C.

The Young's modulus of glass of the present invention is preferably from 75 to 95 GPa. If it is less than 75 GPa, the mechanical strength is likely to be inadequate. It is more preferably at least 78 GPa, typically at least 80 GPa. If it exceeds 95 GPa, at the time of polishing the glass, the polishing rate tends to be low. It is more preferably at most 90 GPa.

The devitrification temperature of the glass of the present invention is preferably at most 1,200° C. If it exceeds 1,200° C., the production yield tends to be poor, or the temperature during the molding tends to be high, whereby the load on the installation increases. It is more preferably less than 1,200° C., more preferably at most 1,150° C., particularly preferably at most 1,100° C.

The glass plate of the present invention is obtainable by chemically tempering a glass plate made of the glass for chemical tempering of the present invention. Further, a chemically tempered glass plate produced by the method for producing chemically tempered glass of the present invention wherein the glass for chemical tempering is a glass plate, is the glass plate of the present invention.

The method for producing a glass plate made of the glass for chemical tempering of the present invention is not particularly limited, and the glass plate is produced, for example, by mixing various materials in appropriate amounts, heating the mixture to from about 1,400 to about 1,600° C. to melt it, then defoaming and homogenizing it by stirring, forming it into a plate shape by a well-known float process, down draw method (e.g. fusion method), press method or the like, annealing the plate shape product and cutting it in a desired size, followed by polishing.

The chemical tempering method is not particularly limited so long as Li₂O and Na₂O in the surface layer of the glass plate can be ion exchanged with Na₂O and K₂O in the molten salt, and a method may, for example, be mentioned wherein the glass plate is immersed in a heated sodium nitrate (NaNO₃) molten salt, potassium nitrate (KNO₃) molten salt or mixed molten salt thereof. Otherwise, firstly, the glass plate may be immersed in a nitrate containing NaNO₃ and then immersed in a nitrate containing KNO₃.

The content of sodium nitrate in the molten salt is preferably at least 10 mass % for chemical tempering at a low temperature in a short time. If it is less than 10 mass %, the surface compressive stress or the thickness of the surface compressive stress layer tends to be small. It is preferably at least 20 mass %, more preferably at least 40 mass %, particularly preferably at least 60 mass %.

It is not essential that potassium nitrate is contained in the molten salt, but may be contained up to 90 mass % to control the chemical tempering properties. If it exceeds 90%, the surface compressive stress or the thickness of the surface compressive stress layer is likely to be small. It is preferably at most 80%, more preferably at most 60%, particularly preferably at most 40 mass %.

It is not essential that lithium nitrate is contained in the molten salt, but may be contained up to 7 mass % to control the chemical tempering properties or to reduce the warpage after the chemical tempering. If it exceeds 7 mass %, the surface compressive stress is likely to be small. It is preferably at most 6 mass %, more preferably at most 4 mass %, particularly preferably at most 2 mass %.

The conditions for forming a chemically tempered layer (surface compressive stress layer) having a desired surface compressive stress on the glass plate vary depending on the thickness of the glass plate, and typically, the glass plate is immersed in an alkali nitrate molten salt at from 300 to 450° C. for from 10 minutes to 4 hours. From the economical viewpoint, the glass plate is preferably immersed at from 300 to 425° C. for from 10 minutes to 2 hours.

Now, the composition of the glass of the present invention will be described by using contents represented by mole percentage unless otherwise specified.

SiO₂ is a component to constitute a glass matrix and is essential. If it is less than 60%, stability of glass tends to deteriorate, or the glass is likely to be brittle. It is preferably at least 62%, more preferably at least 63%. In a case where Al₂O₃ is at most 8% or less than 8%, SiO₂ is preferably at least 66%, more preferably at least 67%, typically at least 68%. In the glass A of the present invention, particularly one wherein Al₂O₃ is at most 8%, in order to avoid deterioration of the stability as glass, SiO₂ is at least 66%, preferably at least 67%, more preferably at least 68%. If SiO₂ exceeds 75%, the viscosity of glass will be increased, and the melting property is remarkably lowered. It is preferably at most 73%, more preferably at most 72%. In a case where Al₂O₃ is at least 8%, SiO₂ is preferably at most 73%. In the glass B of the present invention, SiO₂ is at most 73%, preferably at most 70%, more preferably at most 67%.

Al₂O₃ is a component to improve the ion exchange rate and is essential. If it is less than 5%, the surface compressive stress tends to be inadequate. It is preferably at least 5.5%. In a case where it is desired to further improve the ion exchange rate or further increase the surface compressive stress, Al₂O₃ is preferably at least 8%, particularly preferably at least 9%, typically at least 10%. In the glass B of the present invention, in order to further improve the ion exchange rate, Al₂O₃ is at least 8%, preferably at least 9%, more preferably at least 10%.

If Al₂O₃ exceeds 15%, the viscosity of the glass will be high, and homogenous melting tends to be difficult, or surface roughing is likely to occur after the chemical tempering. It is preferably at most 14%. In a case where it is desired to prevent devitrification i.e. to improve the devitrification resistance, Al₂O₃ is preferably less than 9%, more preferably at most 8% or less than 8%, typically at most 7.5%.

In the glass A of the present invention, Al₂O₃ is less than 9%. If it is 9% or more, the devitrification resistance tends to be poor, and the production yield tends to deteriorate, or the temperature for molding tends to be high, whereby a higher load tends to be exerted to the installation. Therefore, the content of Al₂O₃ is preferably at most 8% or less than 8%, more preferably at most 7%, typically at most 6%.

MgO is essential to improve the melting property or the Young's modulus of glass. If it is less than 1%, the effect to improve the Young's modulus tends to be small. It is preferably at least 1.5%, and in the glass B of the present invention, it is typically at least 2%.

If MgO exceeds 12%, the devitrification resistance tends to deteriorate. In a case where it is desired to further increase the ion exchange rate, MgO is preferably at most 7%, more preferably at most 6%, typically at most 4%. In the glass A of the present invention, particularly one wherein Al₂O₃ is at most 8%, and in the glass B of the present invention, in order to increase the ion exchange rate, MgO is at most 7%, preferably at most 6%, more preferably at most 4%.

CaO is not essential, but may be contained up to 3% e.g. to improve the melting property of glass. If it exceeds 3%, the ion exchange is likely to be hindered, and a desired surface compressive stress layer tends to be hardly formed, or the glass is susceptible to scratching. It is preferably at most 2%, and for example, in a case where it is desired to complete tempering in a short time, it is preferred that no CaO is contained.

ZrO₂ is not essential but may be contained up to 3% to improve the weather resistance and the melting property of glass, or for another purpose. If it exceeds 3%, the glass will be fragile, or a phase separation phenomenon is likely to occur. It is preferably at most 2.5%, typically at most 2%.

Li₂O is a component to form a surface compressive stress layer by ion exchange and to improve the melting property of glass and is thus essential. If it is less than 10%, it tends to be difficult to form a desired surface compressive layer by ion exchange. It is preferably at least 12%, more preferably at least 14%. If Li₂O exceeds 20%, the weather resistance tends to deteriorate. It is preferably at most 18%, more preferably at most 17%.

Na₂O is not essential, but is a component to form a surface compressive stress layer by ion exchange and to improve the melting property of glass and may be contained up to 8%. If Na₂O exceeds 8%, the surface compressive stress tends to be low. It is preferably at most 6%, more preferably at most 5%. In a case where Na₂O is contained, in order to form a desired surface compressive stress layer by ion exchange, its content is preferably at least 1%, more preferably at least 2%.

In the glass A of the present invention, particularly one wherein Al₂O₃ is at most 8%, even in a case where Na₂O is contained, its content is at most 6%, preferably at most 5%.

In the glass B of the present invention, Na₂O is essential. If Na₂O is less than 1%, it tends to be difficult to form a desired surface compressive stress layer by ion exchange, and it is preferably at least 2%.

K₂O is not essential but may be contained up to 5% e.g. to improve the melting property. If K₂O exceeds 5%, the surface compressive stress tends to be low. It is preferably at most 4%, more preferably at most 2%, and in a case where it is desired to increase the scratch resistant strength, it is preferred that no K₂O is contained.

Na₂O+K₂O is preferably at most 10%. If the total content exceeds 10%, the surface compressive stress may deteriorate. In a case where Na₂O or K₂O is contained, Na₂O+K₂O is typically at least 1%.

In the glass A of the present invention, particularly one wherein Al₂O₃ is at most 8%, Na₂O+K₂O is preferably at most 6%, more preferably at most 5%. In the glass B of the present invention, Na₂O+K₂O is from 2.5 to 10%, typically from 3 to 8%.

In order to further increase the surface compressive stress, Li₂O—b(Na₂O+K₂O) is preferably from 4 to 17.5%. If it is less than 4%, the surface compressive stress may not be sufficiently increased. It is more preferably at least 6%, particularly preferably at least 8%. If it exceeds 17.5%, the weather resistance may deteriorate. It is more preferably at most 17%, typically at most 15%.

In the glass A of the present invention, particularly one wherein Al₂O₃ is at most 8%, in order to further increase the surface compressive stress, Li₂O—(Na₂O+K₂O) is preferably at least 8%, more preferably at least 10%. If it exceeds 17%, the weather resistance may deteriorate. It is more preferably at most 15%.

If the total content R₂O of Li₂O, Na₂O and K₂O exceeds 25%, the chemical durability including the weather resistance of glass tends to be low. The total content is preferably at most 23%, more preferably at most 21%. R₂O is preferably at least 14%. If it is less than 14%, the desired ion exchange properties may not be obtainable. It is more preferably at least 16%.

In order to obtain sufficient strength by chemical tempering at a low temperature or in a short period of time, Li₂O/R₂O is required to be within a range of from 0.5 to 1.0. It is preferably from 0.6 to 1.0, more preferably from 0.6 to 0.9.

In the glass A of the present invention, particularly one wherein Al₂O₃ is at most 8%, Li₂O/R₂O is from 0.6 to 1.0, preferably at least 0.7, typically at least 0.8 or more than 0.8, and typically at most 0.95 or at most 0.9. In the glass B of the present invention, Li₂O/R₂O is preferably from 0.6 to 0.9, and in a case where it is desired to increase the surface compressive stress, it is preferably at least 0.7, typically at least 0.8.

In order to obtain a surface compressive stress of at least 300 MPa by chemical tempering at a low temperature or in a short period of time, 2×(Al₂O₃+ZrO₂+Li₂O)+MgO−Na₂O−K₂O is preferably at least 40%. It is more preferably at least 42%, particularly preferably at least 45%, further preferably at least 50%.

The glass of the present invention essentially comprises the above-described components, but may contain other components within a range not to impair the object of the present invention. In a case where such other components are contained, the total content of such components is preferably at most 10%, typically at most 5%. Now, such other components will be exemplified.

Each of SrO and BaO has a high effect of decreasing the ion exchange rate, and accordingly they are preferably not contained, or even if contained, the total content is preferably less than 1%.

As a clarifying agent at the time of melting glass, SO₃, a chloride or a fluoride may suitably be contained. However, in order to increase the visibility of display devices, it is preferred to reduce contamination of impurities such as Fe₂O₃, NiO or Cr₂O₃ having an absorption in a visible light range in raw materials as far as possible, and the content of each of them is preferably at most 0.15%, more preferably at most 0.05% as represented by mass percentage.

Further, if B₂O₃ is contained, it tends to be difficult to obtain homogenous glass, and molding of the glass tends to be difficult, and from such a viewpoint, it is preferred that substantially no B₂O₃ is contained.

The display device of the present invention is typically, with respect to portable devices, a cell phone, a personal digital assistant (PDA), a smart phone, a net book or a car navigation system, and with respect to devices not assumed to be carried, a flat screen television (including a 3D television) such as a liquid crystal television or a plasma television, or a display of e.g. a desktop personal computer or a display for a monitor. Further, from another viewpoint, a touch panel may also be mentioned.

### EXAMPLES

With respect to Examples 1 to 45 in Tables 1 to 5, glass raw materials were suitably selected to have compositions as represented by mole percentage in columns for SiO₂ to K₂O and weighed to be 350 g as glass. To the weighed raw materials, sodium sulfate was added in an amount corresponding to 0.2% of the mass of the weighed raw materials, followed by mixing. Then, the mixed raw materials were put into a platinum crucible, which was then put in a resistance heat type electric furnace at 1,600° C., and the raw material mixture was melted for 3 hours, defoamed and homogenized. The obtained molten glass was cast into a mold and maintained at a temperature of Tg+20° C. for one hour, and then cooled to room temperature at a rate of 1° C./min to obtain a glass block. The glass block was cut and polished and finally both surfaces were mirror polished to obtain plate-form glass having a thickness of 1.0 mm.

In these Tables, X is 2×(Al₂O₃+ZrO₂+Li₂O)+MgO−Na₂O−K₂O.

Examples 1 to 42 are working examples of the present invention, Examples 43 and 44 are comparative examples, and Example 45 is a reference example.

With respect to these glasses, the glass transition point Tg (unit: ° C.), the specific gravity d, the average linear expansion coefficient a (unit: 10⁻⁷/° C.) at from 50 to 350° C., the Young's modulus E (unit: GPa), and the devitrification temperature Tx (unit: ° C.) at which crystals precipitate, are shown in Tables. In Tables, “-” indicates “not measured”.

Tx was measured as follows. That is, about 0.5 cm³ of glass is put on a platinum dish, which is then put in an electric furnace preliminarily set to have a prescribed temperature. After holding it at this temperature for 17 hours, the platinum dish is taken out and left to cool in the atmospheric air. The obtained glass is observed by an optical microscope to see the presence or absence of crystals, and the temperature at which crystals are observed, is taken as the devitrification temperature Tx. Further, in Tables, e.g. Tx being 1,175-1,200 means that Tx is within a range of at least 1,175° C. and less than 1,200° C.

Tx is preferably less than 1,200° C.

The measured results of Tx will be described with reference to Example 16 as an example. With respect to the glass in Example 16, crystals were observed when it was introduced into the electric furnace of 1,175° C., while no crystals were observed when it was introduced into the electric furnace of 1,200° C. Thus, it was found that Tx in Example 16 is within a range of at least 1,175° C. and less than 1,200° C.

The glass in Example 5 and the glass in Example 3 having ZrO₂ in Example 5 partially substituted by Al₂O₃, were indented with a Vickers indenter under such conditions that the temperature was from 23 to 25° C. and the humidity was from 40 to 60%, and the load under which the cracking incidence became 50%, was measured. Such a load was from 1.0 to 2.0 kg in Example 5 and from 0.5 to 1.0 kg in Example 3. Thus, it was found that cracking tends to occur as the ZrO₂ amount is increased.

Then, with respect to glass plates in Examples 1 to 45, the following chemical tempering treatment was carried out. That is, these glass plates were, respectively, immersed in a NaNO₃ molten salt at 400° C. for one hour to carry out chemical tempering treatment.

With respect to the glass plates subjected to the chemical tempering treatment, the surface compressive stress S (unit: MPa) and the thickness t (unit: μm) of the compressive stress layer were measured by a birefringence imaging system Abrio (tradename) manufactured by TOKYO INSTRUMENTS, INC., respectively. Here, at the time of measuring the above S and t, a glass plate having a size of 20 mm×10 mm and a thickness of 1.0 mm was mirror-polished from both sides to have a width of 0.2 mm, which was used as a sample for measurement. The results are, respectively, shown in Tables. S in Example 38 is one estimated from the composition.

TABLE 1

| Ex. | 1 | 2 | 3 | 4 | 5 | 6 | 7 | 8 | 9 | 10 |
|---|---|---|---|---|---|---|---|---|---|---|
| SiO₂ | 64.0 | 64.0 | 64.0 | 64.0 | 64.0 | 66.0 | 62.0 | 64.0 | 64.0 | 64.0 |
| Al₂O₃ | 12.0 | 12.0 | 12.0 | 12.0 | 13.0 | 10.0 | 14.0 | 12.0 | 12.0 | 12.0 |
| MgO | 2.0 | 2.0 | 2.0 | 6.0 | 2.0 | 2.0 | 2.0 | 4.0 | 6.0 | 2.0 |
| CaO | 0 | 0 | 0 | 0 | 0 | 0 | 0 | 0 | 0 | 0 |
| ZrO₂ | 2.0 | 2.0 | 2.0 | 2.0 | 1.0 | 2.0 | 2.0 | 2.0 | 2.0 | 2.0 |
| Li₂O | 12.0 | 12.0 | 16.0 | 12.0 | 16.0 | 16.0 | 16.0 | 14.4 | 12.8 | 16.0 |
| Na₂O | 8.0 | 4.0 | 4.0 | 4.0 | 4.0 | 4.0 | 4.0 | 3.6 | 3.2 | 2.0 |
| K₂O | 0 | 4.0 | 0 | 0 | 0 | 0 | 0 | 0 | 0 | 2.0 |
| R₂O | 20.0 | 20.0 | 20.0 | 16.0 | 20.0 | 20.0 | 20.0 | 18.0 | 16.0 | 20.0 |
| Na₂0 + K₂0 | 8.0 | 8.0 | 4.0 | 4.0 | 4.0 | 4.0 | 4.0 | 3.6 | 3.2 | 4.0 |
| Li₂0/R₂0 | 0.60 | 0.60 | 0.80 | 0.75 | 0.80 | 0.80 | 0.80 | 0.80 | 0.80 | 0.80 |
| X | 46.0 | 46.0 | 58.0 | 54.0 | 58.0 | 54.0 | 62.0 | 57.2 | 56.4 | 58.0 |
| S | 441 | 518 | 528 | 484 | 576 | 468 | 506 | 592 | 557 | 489 |
| t | 88 | 76 | 81 | 65 | 86 | 72 | 73 | 68 | 65 | 52 |
| d | 2.48 | 2.48 | 2.47 | 2.49 | 2.45 | 2.46 | 2.48 | 2.48 | 2.49 | 2.41 |
| α | 83.3 | 87.0 | 80.3 | 70.7 | 79.2 | 78.0 | 76.9 | 73.4 | 69.1 | 82.0 |
| Tg | 542 | 544 | 542 | 595 | 539 | 534 | 580 | 581 | 596 | 513 |
| E | 86.1 | 83.7 | 85.7 | 86.4 | 84.6 | 84.1 | 85.4 | 85.3 | 86.1 | 81.8 |
| Tx | >1250 | — | — | — | 1201-1250 | 1150-1175 | >1250 | >1250 | >1250 | — |

TABLE 2

| Ex. | 11 | 12 | 13 | 14 | 15 | 16 | 17 | 18 | 19 | 20 |
|---|---|---|---|---|---|---|---|---|---|---|
| SiO₂ | 65.0 | 65.5 | 64.0 | 64.0 | 66.0 | 68.0 | 69.0 | 64.0 | 70.0 | 72.0 |
| Al₂O₃ | 12.0 | 12.0 | 12.0 | 12.0 | 10.0 | 8.0 | 8.0 | 12.0 | 6.0 | 7.0 |
| MgO | 2.0 | 2.0 | 2.0 | 2.0 | 6.0 | 2.0 | 3.0 | 3.0 | 2.0 | 2.0 |
| CaO | 0 | 0 | 0 | 0 | 0 | 0 | 0 | 1.0 | 0 | 0 |
| ZrO₂ | 1.0 | 0.5 | 2.0 | 2.0 | 2.0 | 2.0 | 0.0 | 2.0 | 2.0 | 1.0 |
| Li₂O | 16.0 | 16.0 | 17.0 | 16.0 | 12.8 | 16.0 | 15.0 | 14.4 | 16.0 | 16.0 |
| Na₂O | 4.0 | 4.0 | 3.0 | 1.0 | 3.2 | 4.0 | 5.0 | 3.6 | 4.0 | 2.0 |
| K₂O | 0 | 0 | 0 | 3.0 | 0 | 0 | 0 | 0 | 0 | 0 |
| R₂O | 20.0 | 20.0 | 20.0 | 20.0 | 16.0 | 20.0 | 20.0 | 18.0 | 20.0 | 18.0 |
| Na₂0 + K₂0 | 4.0 | 4.0 | 3.0 | 4.0 | 3.2 | 4.0 | 5.0 | 3.6 | 4.0 | 2.0 |
| Li₂0/R₂0 | 0.80 | 0.80 | 0.85 | 0.80 | 0.80 | 0.80 | 0.75 | 0.80 | 0.80 | 0.89 |
| X | 56.0 | 55.0 | 61.0 | 58.0 | 52.4 | 50.0 | 44.0 | 56.2 | 46.0 | 48.0 |
| S | 513 | 510 | 525 | 444 | 530 | 350 | 385 | 543 | 392 | 337 |
| t | 80 | 86 | 84 | 44 | 71 | 84 | 81 | 68 | 84 | 85 |
| d | 2.44 | 2.43 | 2.41 | 2.41 | 2.48 | 2.46 | 2.45 | 2.48 | 2.45 | 2.40 |
| α | 79.8 | 79.2 | 77.2 | 79.4 | 69.4 | 79.0 | 76.0 | 74.7 | 77.7 | 70.7 |
| Tg | 531 | 524 | 530 | 526 | 575 | 513 | 505 | 565 | 503 | 511 |
| E | 84.1 | 83.4 | 85.4 | 83.0 | 88.0 | 86.0 | 82.4 | 86.7 | 84.8 | 83.6 |
| Tx | — | 1175-1200 | — | — | >1200 | 1175-1200 | 1024-1054 | — | <1000 | 1099-1125 |

TABLE 3

| Ex. | 21 | 22 | 23 | 24 | 25 | 26 | 27 | 28 | 29 | 30 |
|---|---|---|---|---|---|---|---|---|---|---|
| SiO₂ | 72.0 | 70.0 | 69.0 | 70.0 | 70.0 | 70.0 | 70.0 | 70.0 | 70.0 | 70.0 |
| Al₂O₃ | 6.0 | 6.0 | 7.0 | 6.0 | 6.0 | 6.0 | 6.0 | 6.0 | 6.0 | 6.0 |
| MgO | 2.0 | 4.0 | 2.0 | 2.0 | 2.0 | 3.0 | 2.0 | 3.0 | 2.5 | 2.0 |
| CaO | 0 | 0 | 0 | 0 | 0 | 1.0 | 2.0 | 0 | 0.5 | 1.0 |
| ZrO₂ | 2.0 | 2.0 | 2.0 | 2.0 | 2.0 | 2.0 | 2.0 | 2.0 | 2.0 | 2.0 |
| Li₂O | 16.0 | 16.0 | 16.0 | 17.0 | 18.0 | 16.0 | 16.0 | 16.0 | 16.0 | 16.0 |
| Na₂O | 2.0 | 2.0 | 4.0 | 3.0 | 2.0 | 2.0 | 2.0 | 3.0 | 3.0 | 3.0 |
| K₂O | 0 | 0 | 0 | 0 | 0 | 0 | 0 | 0 | 0 | 0 |
| R₂O | 18.0 | 18.0 | 20.0 | 20.0 | 20.0 | 18.0 | 18.0 | 19.0 | 19.0 | 19.0 |
| Na₂0 + K₂0 | 2.0 | 2.0 | 4.0 | 3.0 | 2.0 | 2.0 | 2.0 | 3.0 | 3.0 | 3.0 |
| Li₂0/R₂0 | 0.89 | 0.89 | 0.80 | 0.85 | 0.90 | 0.89 | 0.89 | 0.84 | 0.84 | 0.84 |
| X | 48.0 | 50.0 | 48.0 | 49.0 | 52.0 | 49.0 | 48.0 | 48.0 | 47.5 | 47.0 |
| S | 395 | 441 | 401 | 359 | 394 | 463 | 402 | 398 | 401 | 393 |
| t | 85 | 70 | 85 | 80 | 76 | 64 | 64 | 74 | 70 | 70 |
| d | 2.43 | 2.44 | 2.45 | 2.44 | 2.44 | 2.45 | 2.46 | 2.44 | 2.45 | 2.45 |
| α | 70.2 | 71.4 | 77.0 | 77.9 | 74.9 | 72.1 | 71.2 | 75.1 | 74.4 | 75.6 |
| Tg | 523 | 518 | 511 | 502 | 511 | 519 | 509 | 508 | 512 | 501 |
| E | 84.4 | 86.2 | 85.3 | 85.0 | 85.3 | 86.1 | 86.4 | 85.4 | 85.5 | 85.6 |
| Tx | 1075-1090 | 1100-1125 | 1024-1050 | 1049-1074 | 1050-1075 | 1100-1107 | 1074-1101 | 1027-1050 | 1025-1042 | 1017-1024 |

TABLE 4

| Ex. | 31 | 32 | 33 | 34 | 35 | 36 | 37 | 38 | 39 | 40 |
|---|---|---|---|---|---|---|---|---|---|---|
| SiO₂ | 70.0 | 70.0 | 70.0 | 70.0 | 70.0 | 69.0 | 64.0 | 64.0 | 64.0 | 64.0 |
| Al₂O₃ | 6.0 | 7.0 | 6.0 | 7.0 | 6.0 | 5.5 | 8.0 | 10.0 | 8.0 | 8.0 |
| MgO | 1.5 | 2.0 | 3.0 | 2.0 | 3.0 | 3.5 | 11.0 | 9.0 | 11.0 | 11.0 |
| CaO | 1.5 | 0 | 0 | 0 | 0 | 0 | 0 | 0 | 0 | 0 |
| ZrO₂ | 2.0 | 2.0 | 2.0 | 2.0 | 2.0 | 2.0 | 0.5 | 0.5 | 0.5 | 0.5 |
| Li₂O | 16.0 | 16.0 | 16.0 | 15.0 | 15.0 | 16.0 | 12.5 | 12.5 | 14.5 | 15.5 |
| Na₂O | 3.0 | 3.0 | 3.0 | 4.0 | 4.0 | 2.0 | 4.0 | 4.0 | 2.0 | 1.0 |
| K₂O | 0 | 0 | 0 | 0 | 0 | 2.0 | 0 | 0 | 0 | 0 |
| R₂O | 19.0 | 19.0 | 19.0 | 19.0 | 19.0 | 20.0 | 16.5 | 16.5 | 16.5 | 16.5 |
| Na₂0 + K₂0 | 3.0 | 3.0 | 3.0 | 4.0 | 4.0 | 4.0 | 4.0 | 4.0 | 2.0 | 1.0 |
| Li₂0/R₂0 | 0.84 | 0.84 | 0.84 | 0.79 | 0.79 | 0.80 | 0.76 | 0.76 | 0.88 | 0.94 |
| X | 46.5 | 49.0 | 48.0 | 46.0 | 45.0 | 46.5 | 49.0 | 51.0 | 55.0 | 58.0 |
| S | 381 | 408 | 411 | 403 | 385 | 354 | 426 | 440 | 484 | 512 |
| t | 71 | 82 | 76 | 84 | 81 | 53 | 50 | 59 | 46 | 44 |
| d | 2.45 | 2.44 | 2.44 | 2.45 | 2.45 | 2.45 | 2.47 | 2.46 | 2.46 | 2.46 |
| α | 76.1 | 77.2 | 76.3 | 79.6 | 76.0 | 81.8 | 77.9 | 74.4 | 73.2 | 70.5 |
| Tg | 508 | 512 | 506 | 509 | 505 | 495 | 532 | 556 | 539 | 552 |
| E | 85.9 | 82.6 | 82.9 | 82.2 | 82.4 | 84.1 | 88 | 85 | 89 | 90 |
| Tx | 1028-1049 | 1050-1075 | 1025-1050 | 1026-1051 | 998-1025 | 900-925 | >1200 | — | — | >1200 |

TABLE 5

| | Ex. | | | | |
|---|---|---|---|---|---|
| | 41 | 42 | 43 | 44 | 45 |
| SiO₂ | 64.0 | 64.0 | 69.0 | 69.0 | 68.0 |
| Al₂O₃ | 9.65 | 11.3 | 4.0 | 6.0 | 11.3 |
| B₂O₃ | 0 | 0 | 0 | 0 | 3.9 |
| MgO | 11.0 | 11.0 | 5.0 | 3.0 | 0.1 |
| CaO | 0 | 0 | 0 | 0 | 4.4 |
| ZrO₂ | 0.5 | 0.5 | 2.0 | 1.0 | 0.4 |
| Li₂O | 11.25 | 10.0 | 8.0 | 9.0 | 10.5 |
| Na₂O | 3.6 | 3.2 | 12.0 | 7.0 | 1.2 |
| K₂O | 0 | 0 | 0 | 5.0 | 0.2 |
| R₂O | 14.9 | 13.2 | 20.0 | 21.0 | 11.9 |
| Na₂0 + K₂0 | 3.6 | 3.2 | 12.0 | 12.0 | 1.4 |
| Li₂0/R₂0 | 0.76 | 0.76 | 0.40 | 0.43 | 0.88 |
| X | 50.2 | 51.4 | 21.0 | 23.0 | 43.1 |
| S | 374 | 395 | 191 | 135 | 363 |
| t | 64 | 64 | 67 | 48 | 52 |
| d | 2.46 | 2.46 | 2.49 | 2.45 | 2.42 |
| α | 70.3 | 65.2 | 93.5 | 101.5 | 57.4 |
| Tg | 568 | 598 | 482 | 469 | 576 |
| E | 88 | 88 | 79.6 | 76.9 | 82 |
| Tx | — | — | 998-1025 | 998-1025 | 1225-1249 |

As is evident from the above results, in Examples of the present invention, S is at least 300 MPa, and t is at least 50 μm, after chemical tempering treatment of glass, and thus, the desired compressive stress layer is obtainable by chemical tempering treatment in such a short period of time of one hour.

In Comparative Examples, S in Examples 43 and 44 was less than 200 MPa, and thus no adequate compressive stress was obtainable. In Example 45, B₂O₃ is contained as much as 3.9%, and therefore bricks in the glass melting furnace are likely to be eroded, and due to sublimation of B₂O₃, a heterogeneous basis material is likely to be included in the molten glass.

From a comparison between Examples 1 and 3 having the same contents except for the content of an alkali metal oxide, it is evident that S becomes high as the Li₂O/R₂O ratio becomes large, since S in Example 1 wherein Li₂O/R₂O is 0.60, is 441 MPa, while S in Example 3 wherein Li₂O/R₂O is 0.80, is 528 MPa. Likewise, from a comparison among Examples 37, 39 and 40 having the same contents except for the content of an alkali metal oxide, it is evident that S becomes high as the Li₂O/R₂O ratio becomes large, since S in Example 37 wherein Li₂O/R₂O is 0.76, is 426 MPa, S in Example 39 wherein Li₂O/R₂O is 0.88, is 484 MPa, and S in Example 40 wherein Li₂O/R₂O is 0.94, is 512 MPa.

Further, with respect to the glass plates in Examples 5 and 19, chemical tempering treatment was carried out by immersing them for one hour in a molten salt at 400° C. containing NaNO₃ and KNO₃ in the proportions shown by mass % in Table 6. S and t of the obtained chemically tempered glass are shown in the same Table, whereby it is evident that S becomes large as the content of NaNO₃ becomes large.

TABLE 6

Composition of molten salt

| | NaNO₃ | 100% | 75% | 50% | 25% |
|---|---|---|---|---|---|
| | KNO₃ | 0 | 25% | 50% | 75% |
| Ex. 5 | S | 576 | 518 | 491 | 477 |
| | t | 86 | 91 | 93 | 94 |
| Ex. 19 | S | 392 | — | 331 | — |
| | t | 84 | — | 89 | — |

### INDUSTRIAL APPLICABILITY

The glass of the present invention is useful for e.g. a cover glass for display devices. Further, it is useful also for e.g. a solar cell substrate or a window glass for aircrafts.

The entire disclosures of Japanese Patent Application No. 2011-092140 filed on Apr. 18, 2011, Japanese Patent Application No. 2011-092141 filed on Apr. 18, 2011 and Japanese Patent Application No. 2011-274695 filed on Dec. 15, 2011 including specifications, claims, drawings and summaries are incorporated herein by reference in their entireties.

What is claimed is:

1. Glass for chemical tempering, which comprises, as represented by mole percentage based on the following oxides, from 60 to 75% of SiO₂, from 5 to 15% of Al₂O₃, more than 7 and at most 12% of MgO, from 0 to 3% of CaO, from 0 to 3% of ZrO₂, from 10 to 20% of Li₂O, from 0 to 8% of Na₂O and from 0 to 5% of K₂O, and has a total content R₂O of Li₂O, Na₂O and K₂O of at most 25%, and a ratio Li₂O/R₂O of the Li₂O content to R₂O of from 0.5 to 1.0.
